(19) United States
(12) Patent Application Publication
(10) Pub. No.: US 2014/0234517 A1
(43) Pub. Date: Aug. 21, 2014

(54) INSTANT SOLID BEVERAGE AND METHODS OF PREPARATION

(71) Applicants: Rebecca Lian Hwee Peng, Beijing (CN); Michael Wang, Shanghai (CN); ShengHua Zhu, Shanghai (CN); Werner Bauer, Lutry (CH)

(72) Inventors: Rebecca Lian Hwee Peng, Beijing (CN); Michael Wang, Shanghai (CN); ShengHua Zhu, Shanghai (CN); Werner Bauer, Lutry (CH)

(73) Assignee: NESTEC S.A., Vevey (CH)

(21) Appl. No.: 14/127,060

(22) PCT Filed: Jul. 5, 2012
(86) PCT No.: PCT/EP12/63116

§ 371 Date: Dec. 17, 2013

(30) Foreign Application Priority Data
Jul. 7, 2011 (CN) 201110203010.1

(51) Int. Cl. A23L 2/395; A23L 1/03; A23F 5/36

(52) U.S. Cl. CPC A23L 2/395; A23F 5/36; A23L 1/0315
USPC 426/595; 426/590; 426/599; 426/593; 426/658

(57) ABSTRACT

The invention concerns An instant solid beverage in form of granules, each granule (1) comprising: −0.1 to 30% by weight of a beverage concentrate (2), and −60 to 95% by weight of a carbohydrate (3), wherein particles of the carbohydrate (3) construct a meshwork structure of the granule (1), and wherein debris or drops of the beverage concentrate (2) inset dispersedly among the carbohydrate particles meshwork structure (3) or debris or drops of the beverage concentrate (2) act as linkage bridges between particles of the carbohydrate (3), and wherein pores (4) are dispersed within the meshwork structure.

### FIELD OF INVENTION

The present invention relates to an instant solid beverage applicable to a beverage vending machine and a beverage dispenser, preparation methods and use in foodstuff preparation thereof.

### BACKGROUND OF INVENTION

At present, beverage vending machines and beverage dispensers (including single-serve beverage system) are used in more and more places, and thus more and more consumers are willing to accept such a convenient drinking method. The drink provided by a beverage vending machine or beverage dispenser is usually formed by diluting a beverage concentrate or a powdery beverage with water. However, there exist some problems when a common powdery beverage is used in a beverage vending machine. For example, its flowability tends to be worse over time due to the agglomeration of particles caused by the reasons of moisture absorption and static electricity between particles, etc., such that the powder couldn't be dispensed and metered precisely; furthermore, the caking of the powdery beverage often results in the insufficient penetration of water upon rehydration and hence has a bad solubility; additionally, since the powdery material has a tendency of absorbing moisture, the contamination of spoilage microorganisms is liable to occur during its storage; moreover, since the powder size is very fine, it can be dusty and hence cause heavy inhalation during production, distribution, treatment and handling.

Therefore, there has been a need for improving the physical properties such as flowability and solubility of the existing solid beverages so as to increase their applicability in a beverage vending machine and a beverage dispenser.

### SUMMARY

In order to overcome the above shortcomings of existing solid beverages, inventors have developed a solid beverage that is easy to dispense and meter precisely in a beverage vending machine and a beverage dispenser, which not only which that has a good flowability and solubility, but also can deliver more authentic flavour.

Thus, the first object of the present invention is providing a granular instant solid beverage suitable for use in a beverage vending machine and a beverage dispenser.

The second object of the present invention is providing methods for manufacturing the solid beverage.

The third object of the present invention is providing the use of the granular instant solid beverage in foodstuff production.

In order to achieve the above-mentioned objects, the present invention adopts the following technical solution.

According to a first aspect the invention concerns an instant solid beverage in form of granules, each granule comprising:
−0.1 to 30% by weight of a beverage concentrate, and
−60 to 95% by weight of a carbohydrate,
   wherein particles of the carbohydrate construct a meshwork structure of the granule, and wherein debris or drops of the beverage concentrate inset dispersedly among the carbohydrate particles meshwork structure and/or debris or drops of the beverage concentrate act as linkage bridges between particles of the carbohydrate meshwork structure, and wherein pores are dispersed within the meshwork structure.

According to a second aspect, the invention concerns a process for manufacturing the above instant solid beverage, which comprises following steps:
a) mixing the a beverage concentrate and carbohydrate particles with water, and adding auxiliary food additives if necessary, so as to form a mixture, the mixture having a water content ensuring the viscosity of the mixture suitable for forming soft granules in a granulator;
b) subjecting the mixture obtained in step a) to a wet granulation, so as to obtain soft granules;
c) fluidized-bed drying the soft granules obtained in step b);
d) optionally screening the solid beverage granules fulfilling the form and size requirements; and
e) optionally packaging.

According to a third aspect, the invention concerns another process for manufacturing the above instant solid beverage, which comprises of the following steps:
a) pulverizing carbohydrate particles, or mixing and pulverizing the carbohydrate particles and if necessary auxiliary food additive(s), so as to form a powder having a particle size of not more than 200 μm;
b) granulating in a fluidized-bed granulator by taking the powder obtained in step a) as a suspension material and taking an aqueous liquid comprising the beverage concentrate or an aqueous liquid comprising the beverage concentrate and if necessary auxiliary food additive(s) as an agglutinant, and then cooling, so as to form granular products containing 0.2 to 5% by weight of water, wherein the agglutinant has a water content ensuring the viscosity of the agglutinant suitable for forming granules in the granulator;
c) optionally screening the solid beverage granules fulfilling the form and size requirements; and
d) optionally packaging.

According to a fourth aspect, the invention concerns the use of the above instant solid beverage in the preparation of a product foodstuff or a beverage or an intermediate product thereof.

According to a fifth aspect, the invention concerns a product foodstuff or a beverage or an intermediate product thereof prepared with the above instant solid beverage.

### BRIEF DESCRIPTION OF DRAWINGS

FIG. 1 is a schematic structure of an instant solid beverage according to the present invention;

FIG. 2 is a process flow chart of a method for preparing an instant solid beverage according to the present invention;

FIG. 3 is a process flow chart of another method for preparing an instant solid beverage according to the present invention.

### DETAILED DESCRIPTION OF EMBODIMENT

The solutions embodying the conception of the present invention will be described as follows, with reference to the accompanying drawings. It is understood that the embodiment is for the purpose of illustrating the present invention and should not be interpreted as a limitation to the scope of the invention.

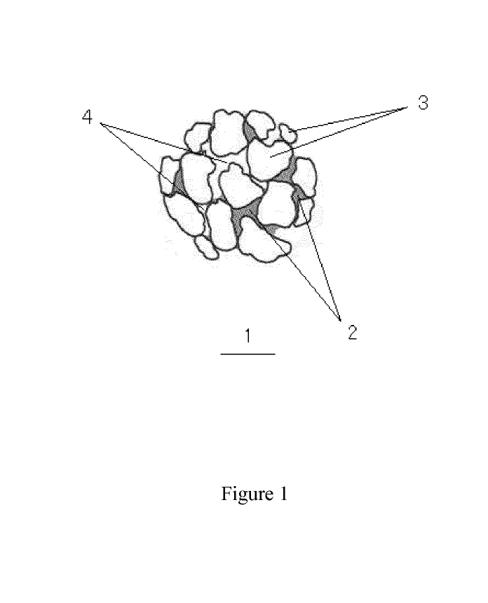

The schematic structure of the granular instant solid beverage 1 of the present invention is illustrated in FIG. 1. The materials of beverage concentrate 2 and carbohydrate particles 3 can form a porosity structure in various manners, so long as the manner facilitates conferring the granules with sufficient flowability and solubility as well as an authentic flavour and/or taste release, which isn't limited to the structure and shape illustrated in FIG. 1. For example, when the components constituting granular instant solid beverage comprises auxiliary food additives, the carbohydrate particles 3 construct the meshwork structure together with auxiliary food additive, and beverage concentrate debris or drops 2 inset dispersedly among the carbohydrate particles 3 and auxiliary food additive particles, and/or beverage concentrate debris or drop 2 act as linkage bridges between carbohydrate particles 3 and/or necessary auxiliary food additive particles. Alternatively, the carbohydrate particles 3 solely construct the meshwork structure, and beverage concentrate debris or drops 2 and auxiliary food additive inset dispersedly among the carbohydrate matrix particles 3, and/or beverage concentrate debris or drops 2 and auxiliary food additive debris or drops act as linkage bridges between carbohydrate particles 3.

For the purpose of convenience, the term “a granular instant solid beverage” mentioned in the present invention sometimes is called briefly “a granular solid beverage”, or “an instant solid beverage granule”, or “a solid beverage granule”, or “a solid beverage”, or “a solid granule” or “a beverage granule” or “an instant solid beverage” and the like. It should be understood that these terms represent the same meaning and range, and thus are exchangeable.

Similarly, for the purpose of convenience, the term “a carbohydrate particle” mentioned in the present invention sometimes is called briefly “a matrix particle”, or “a carbohydrate matrix particle”, or “a carbohydrate matrix material” and the like. It should be understood that these terms represent the same meaning and range, and thus are exchangeable.

In addition, in the context, except for particular explanations or indications, the percentage (%) of respective component refers to the percentage by weight wt %.

### Definitions

### Instant Solid Beverage

An instant solid beverage is a drink formed by formulating various components (e.g., sugar, fruit juice, plant sap and other ingredients), concentrating and drying or by pulverizing various materials and mixing them into granules, pieces or powder, which can be drunk only after dilution with water. According to Chinese national standard GB7101-2003 (Hygienic standard for a solid drink), an instant solid beverage is classified into two series, i.e., protein type solid beverage and traditional type solid beverage: the protein type solid beverage refers to a product having a protein amount of 4 wt % or more, using milk or a milk preparation or other animal or vegetable protein as the main material with or without adding auxiliaries. A traditional type solid beverage refers to a product having a protein amount of lower than 4%, using a fruit juice or the extract of baked coffee, tea, chrysanthemum or other plants as the main material with or without adding auxiliaries.

Preferably, the instant solid beverage of the present invention particularly refers to a type of fruit flavour, a type of coffee, a type of chocolate, or a type of instant tea, and the like.

Preferably, the aqueous amount in the instant solid beverage of the present invention is within a range from 0.2 wt % to 5.0 wt %. For example, the lower limit of the aqueous amount may be 0.2, 0.3, 0.4, 0.5, 0.6, 0.7, 0.8, 0.9, 1.0, 1.1, 1.2, 1.3, 1.4 or 1.5 wt %, and the upper limit of the aqueous amount may be 4.8, 4.7, 4.6, 4.5, 4.4, 4.3, 4.2, 4.1, 4.0, 3.8, 3.6, 3.4, 3.2, 3.0, 2.8, 2.6, 2.4, 2.2 or 2.0 wt %. If the aqueous amount is less than 0.2 wt %, the manufacturing cost and the storage cost tends to increase; on the other hand, if the aqueous amount is higher than 5.0 wt %, the granules are liable to absorb moisture and thus soften, which affects the flowability and reduces its shelf life.

In respect of the structure and the main constituents, carbohydrate matrix particles 3 construct the meshwork structure of the solid beverage granule 1, with multiple pores or cavities 4 disperse within the meshwork.

Due to the pores or cavities 4, the granule 1 has a porous structure rendering easy penetration of water, which facilitates the delivering of the carbohydrate matrix 3 and the beverage concentrate 2, and thus increases the solubility of the solid beverage granule 1. Preferably, the volume of pores 4 represents 5 to 50% v/v of the total volume of a solid beverage granule 1. For example, the lower limit of the volume ratio, i.e., porosity may be 5, 6, 7, 8, 9, 10, 11, 12, 13, 14, 15, 16, 17, 18, 19 or 20% v/v, and the upper limit of the porosity may be 50, 48, 46, 44, 42, 40, 38, 36, 34, 32, 30, 29, 28, 27, 26 or 25% v/v. If the porosity is less than 5% v/v, the effects of increasing the solubility can be insufficient; on the other hand, if the porosity is higher than 50% v/v, the rigidity of a granule tends to decrease, and the granule becomes crisp, which affects the flowability.

### Granule

Although there is no particular limitation on the shape or form of the instant solid beverage of the present invention, provided that the shape allows the solid beverage granule 1 to be dispensed and metered conveniently and precisely in a beverage vending machine and a beverage dispenser, the shape or form is preferably selected from the group consisting of globe, globe-like, semi-globe, column, tablet and cube. More preferably, the shape of a granule is globe, globe-like, or semi-globe.

There is no particular limitation on the particle size of the instant solid beverage granules of the present invention, provided that the particle size allows the solid beverage granule 1 to be dispensed and metered conveniently and precisely in a beverage vending machine. The particle size refers to the diameter of a globe or the equivalent circle diameter of a particle having a non-global shape. The particle size the instant solid beverage granule 1 of the present invention is preferably within a range from 0.5 mm to 5.0 mm. For example, the lower limit of the particle size may be 0.5, 0.6, 0.7, 0.8, 0.9, 1.0, 1.1, 1.2, 1.3, 1.4 or 1.5 mm, and the upper limit of the particle size may be 5.0, 4.8, 4.6, 4.4, 4.2, 4.0, 3.8, 3.6, 3.4, 3.2, 3.0, 2.9, 2.8, 2.7, 2.6 or 2.5 mm.

### Angle of Repose

An angle of repose is a standard for evaluating the flowability of a granule in the powder engineering, it usually refers to a angle of repose measured by Carr method which has been described in detail in US PHARMACOPEIA, General Chapters: <1174> POWDER FLOW and in Carr, R. L. Evaluating Flow Properties of Solids. Chem. Eng. 1965, 72, 163-168.

The angle of repose has been used in several branches of science to characterize the flow properties of solids. Angle of repose is a characteristic related to interparticulate friction or resistance to movement between particles. Angle of repose test results are reported to be very dependent upon the method used. Experimental difficulties arise as a result of segregation of material and consolidation or aeration of the powder as the cone is formed. Despite its difficulties, the method continues to be used in the pharmaceutical industry. In the measurement using a funnel, the relation between the flowabilities and angles of repose is given below.

| | Angle of Repose |
|---|---|
| Flow Property | (degrees) |
| Excellent | 25-30 |
| Good | 31-35 |
| Fair-aid not needed | 36-40 |
| Passable-may hang up | 41-45 |
| Poor-must agitate, vibrate | 46-55 |
| Very poor | 56-65 |
| Very, very poor | >66 |

In order to ensure the sufficient flowability of the instant solid beverage 1 of the present invention so as to allow their convenient and precise dispensation and dosing in a beverage vending machine, the instant solid beverage granule 1 must possess and preserve a suitable angle of repose. The term “to be conveniently dispensed and metered in a beverage vending machine” means that the solid beverage powder can travel from a solid beverage storage chamber to a distributor, a metering device, a pipe, and finally to a beverage forming chamber in the beverage vending machine without external mechanical means such as agitation and vibration, while no adherence to the wall, no clogging, and no inaccurate metering of the solid beverage occurs.

In terms of a solid beverage, its angle of repose mainly depends upon many factors such as the shape, particle size, structure, static absorption, and moisture absorption, etc., and is closely related to the kinds and properties of raw materials, composition of various materials, process procedure, etc.

It is well known that a instant solid beverage has a moisture absorption property, so it readily absorbs moisture and becomes moist after a long-time exposure in the air, and thus particles adhere together and lost flowability. Therefore, in the determination of whether the solid instant beverage can be used in a beverage vending machine, its flowability after a specific period of time, such as 12, 24 and 48 hrs, of exposure in the air must be investigated. In the present invention, the angles of repose after 24 and 48 hrs of exposure in the air are investigated.

Therefore, the angle of repose (a) after 24 hrs exposure in the air of the solid beverage particle 1 as determined by using the Carr method is limited to be 40° or below, for example, an upper limit of the angle of repose may be 40, 39, 38, 37, 36, 35, 34, 33, 32, 31, 30, 29, 28, 27, 26, 25, 24, 23, 22, 21, 20, 19, 18, 17, 16, or 15°.

It is well known that the humidity of the air is usually variable, and the same is true even if within a beverage vending machine. Both the humidity and the temperature of the air influence the moisture absorption property of a solid beverage. In the present application, said temperature of the air refers to the temperature of the surrounding where a beverage vending machine is used, which is usually 0 to 45 ° C. The relative humidity of the air is usually 95% or below, preferably 90% or below, more preferably 85% or below, more preferably 80% or below, more preferably 75% or below, and more preferably 70% or below.

### Carbohydrate Matrix

As illustrated in FIG. 1 the carbohydrate particles 3 are used to form the meshwork structure of the instant solid beverage granules 1, wherein the meshwork structure is formed by constructing an inter-particle solid bridge between the matrix particles 3, and/or by connecting two or more matrix particles 3 with the beverage concentrate 2.

The carbohydrate is a food grade material, and may be at least one selected from a group consisting of starch, modified starch, baking foodstuff powder, gelatin, methylcellulose (MC), hydroxypropyl methylcellulose (HPMC), Sodium carboxyl methyl cellulose (CMC-Na), ethylcellulose (EC), chitosan, dextrin, sorbitol, xylitol, lactose, galactose, maltose, isomaltitol, sucrose, glucose, arabinose, melibiose, mannoside, raffinose, and cellobiose.

In the solid beverage granule, the amount of carbohydrate 3 is comprised between 60 and 95 wt %, wherein the lower limit of the amount may be 60, 62, 64, 66, 68, 70, 72, 74, 76, 78, 80, or 82 wt %, and the upper limit of the amount may be 95, 94, 93, 92, 91, 90, 89, 88, 87, 86, or 85 wt %. If the amount of the carbohydrate is lower than 60 wt %, the structure stability of a granule tends to decrease, and the production cost tends to increase. On the other hand, if the amount is higher than 95 wt %, the instant solid beverage 1 does not exhibit the authentic flavour of the beverage concentrate, and the dissolution rate of the instant solid beverage tends to decrease.

### Beverage Concentrate

As illustrated in FIG. 1 in the instant solid beverage of the present invention the beverage concentrate is dispersedly inset in the meshwork formed by carbohydrate particles, or the beverage concentrate exists as a linkage bridge for connecting carbohydrate matrix particles 3. The beverage concentrate may be in a solid or a liquid form, and is a crucial ingredient of beverages which decides the taste and flavor.

The beverage concentrate is a food grade material, and may be at least one selected from a group consisting of tea and tea extract, baking foodstuff extract, foodstuff juice, fruit pulp, fruit juice, vegetable pulp, vegetable juice, milk, condensed/concentrated milk, coffee concentrate, cocoa concentrate or chicories concentrate, fragrant plant extract, herbal extract, meat broth, synthetic flavor, and the combination thereof.

In the instant solid beverage, the amount of the beverage concentrate is comprised between 0.1 and 30 wt %, wherein the lower limit of the amount may be 0.1, 0.5, 1.0, 1.5, 2.0, 2.5, 3.0, 3.5, 4.0, 4.5, 4.8, or 5.0 wt %, and the upper limit of the amount may be 30, 28, 26, 24, 22, 20, 18, 16, 14, 12, 10, 9, or 8 wt %. If the amount of the beverage concentrate is lower than 0.1 wt %, the solid beverage does not exhibit sufficiently the authentic flavour of the beverage concentrate. On the other hand, if the amount is higher than 30 wt %, the granule readily becomes moist when the beverage concentrate 2 is a liquid, or the granule is ready to absorb moisture and thereby results in a decreased flowability, an increased production cost, and a shortened shelf life.

### Auxiliary Food Additive

Optionally, the solid beverage of the present invention may include auxiliary food additives. According to the physical properties of the additive such as the natural form, moisture absorption property, viscosity, and compatibility with the beverage concentrate, the additive either is incorporated into the carbohydrate matrix to form the meshwork structure of the granule; or is dispersed, together with the beverage concentrate, in the meshwork structure formed by the carbohydrate matrix, or exists as a linkage bridge for connecting two or more carbohydrate matrix particles.

The auxiliary food additive used in the present invention is a food grade material, and may be at least one selected from a group consisting of flavouring agent, edible flavour, edible pigment, edible anti-static agent, edible anti-adhesion agent, edible moisture resistant agent, sweetener, nutrient supplement, disintegrant, expanding agent, lipid, surfactant, preservative, anti-oxidant, sodium chloride, and sodium bicarbonate, etc.

For example, the nutrient supplement is used to strengthen nutrition, for example, Vitamin C series, mineral metal elements, chitin, amino acids, and the like. The surfactant is used to prepare a stable emulsion of the raw material mixture, used for spray-drying granulation and wet granulation, for example, sucrose fatty acid ester and polyoxyethylene sorbitol fatty acid ester such as polysorbate 20 and polysorbate 80.

In the solid beverage, the amount of the auxiliary food additive can represent 0-10 wt % of the granule, wherein the upper limit of the amount may be 10, 9, 8, 7, 6, 5, 4, 3, 2, or 1 wt %.

### Granulation

In order to form the porous structure of the granular instant solid beverage of the present invention, the above raw materials should be subjected to wet granulation methods. Meanwhile, the uniform dispersion of the beverage concentrate and the carbohydrate matrix should be ensured.

In the granulation procedure, the particle sizes of all solid materials are controlled to be 200 μm or less. For example, the upper limit of the particle size may be 200, 195, 190, 185 or 180 μm. If the particle size of all solid materials is higher than 200 μm, the resultant solid beverage granules might have a microstructure different from that of the granular instant solid beverage 1 of the present invention, and thus might have no desired physical properties such as anti-static, anti-adhesion and moisture resistant. The lower limit of the particle size of all solid materials may be 50, 60, 70, 80, 90, 100, 110, 120, 130, 140 or 150 μm. If the particle size of all solid materials is less than 50 μm, it is difficult to ensure that all particles distribute uniformly in the resultant solid beverage granules so as to achieve the effects of the present invention. The narrower the distribution range of a particle size of solid materials is, the more uniform the dispersion of the material particles is. Considering that the particle sizes of a solid material has a distribution profile, usually in Normal distribution, the particle sizes of 75% of all solid materials may fall within the range 120 μm to 200 μm, preferably 130 μm to 195 μm, more preferably 140 μm to 192 μm, and more preferably 150 μm to 190 μm.

There are many wet granulation processes, see, for example, Powder Technology Handbook, Editor Lu Shouci. Chemical Industry Press, Beijing, 2004.

For example, wet granulation processes include high-speed mixing granulation, extrusion-spheronization granulation, fluidized bed granulation, spray-drying granulation, compound granulation (agitation fluidized bed, rotation fluidized bed, agitation and rotation fluidized bed), and the like.

The specific granulation process may be determined according to some factors such as the type of the instant solid beverage, production, economy, and physical and chemical properties of the raw materials.

In one embodiment, the present invention provides a wet granulation-fluidized bed drying process for preparing the granular instant solid beverage, which comprises following steps:
a) mixing the materials of the beverage concentrate and the carbohydrate particles with a suitable amount of water in a mixer, and adding auxiliary food additives if necessary, so as to form a mixture, the mixture having a water content ensuring that the viscosity of the mixture is suitable for forming soft granules in a granulator;
b) subjecting the mixture obtained in step a) to a wet granulation, by using a high-speed mixing granulator, an extrusion-spheronization granulator, or any other device suitable for preparing a granule having a particle size of 0.5-5 mm, so as to obtain soft granules;
c) fluidized-bed drying the soft granules obtained in step b) by using a fluidized bed dryer such as a mono-stage fluidized bed, a multi-stage (2-5 stages) fluidized bed, a horizontal fluidized bed, or a spout-fluidized bed, and cooling to room temperature, so as to obtain a granular product containing 0.2-5.0 wt % of water;
d) optionally screening the granular product fulfilling the form and size requirements; and
e) optionally packaging.

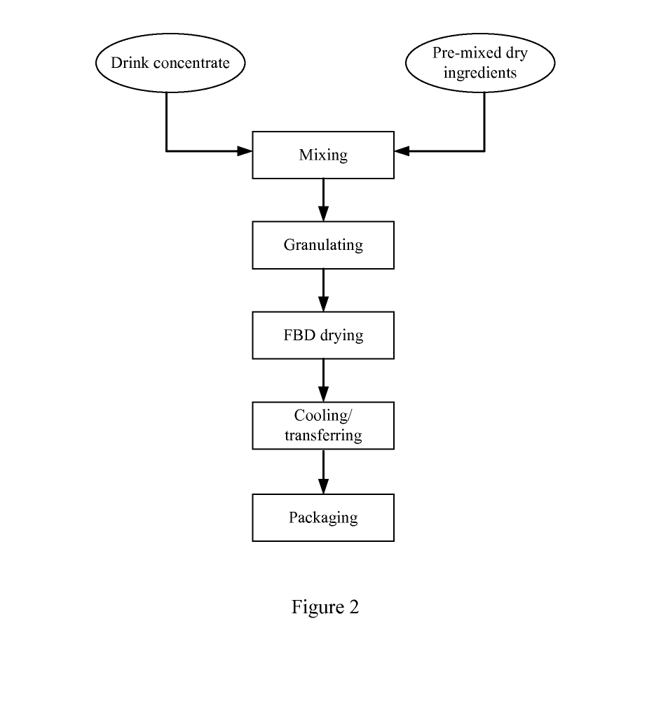

The process is illustrated in FIG. 2. In FIG. 2, the “pre-mixed dry ingredients” include the carbohydrate and if necessary a food additive.

In each step, the selection of the process conditions depends on some factors such as the type of the apparatus, the type of the solid beverage, and the physical and chemical properties of raw materials of the beverage concentrate 2 and the carbohydrate 3 as well as the food additive. For example, the amount of water added can be adjusted according to the type of the granulator, such that the mixture of step b) has a water content ensuring the viscosity of the mixture suitable for forming soft granules having a specified shape and size in a granulator.

In step d) the screening of the granular product enables the selection of granular product presenting the form and size required for storing and dispensing in a beverage dispenser.

In another embodiment, the present invention provides a fluidized-bed wet granulation process for preparing the granular instant solid beverage, which comprises of the following steps:
a) pulverizing the material of the carbohydrate particles 3, or mixing and pulverizing the materials of the carbohydrate particles 3 and if necessary auxiliary food additives, by using a comminutor or a grinder, so as to form powder having a particle size of not more than 200 μm;
b) granulating with the powder obtained in step a) as a suspension material and with the aqueous liquid of the beverage concentrate or the aqueous liquid comprising the beverage concentrate and if necessary auxiliary food additive(s) added as an agglutinant in a fluidized bed granulator such as an agitation fluidized bed, rotation fluidized bed, or agitation and rotation fluidized bed, and then cooling to room temperature, so as to form granular products containing 0.2 to 5% by weight of water, wherein the agglutinant has a water content ensuring the viscosity of the agglutinant suitable for forming granules in the granulator;
c) optionally screening the solid beverage granule fulfilling the form and size requirements; and
d) optionally packaging.

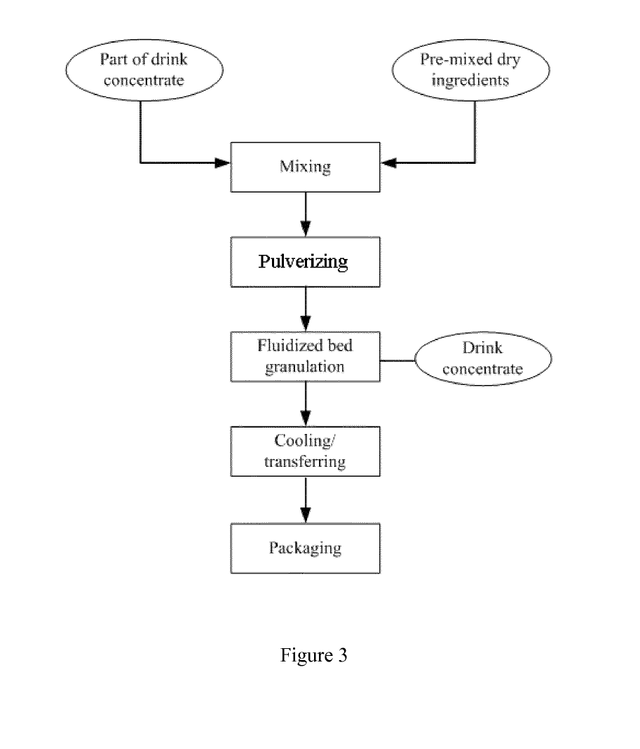

The process is illustrated in FIG. 3. In FIG. 3, the “pre-mixed dry ingredients” include the carbohydrate matrix and if necessary food additive(s).

In each step, the selection of the process conditions depends on some factors such as the type of the apparatus, the type of the solid beverage, and the physical and chemical properties of the raw materials of the beverage concentrate and the carbohydrate as well as the food additive (s).

In the above fluidized bed wet granulation process, the material as the suspension layer in the fluidized bed may be a uniform mixture of the carbohydrate, the solid food additive powder and part of the beverage concentrate, while the agglutinant is the aqueous liquid of the rest of the beverage concentrate. In other words, the beverage concentrate 2 may be completely mixed with the pre-mixed dry ingredients in a lump, or be mixed with the pre-mixed dry ingredients in batches.

In the embodiment, the water content in the agglutinant, and the mixing manner of the beverage concentrate, the carbohydrate and the food additive(s) are determined according to the requirements of the process and the product.

In step d) the screening of the granular product enables the selection of granular product presenting the form and size required for storing and dispensing in a beverage dispenser.

The apparatuses used in the embodiments of the present invention are those commonly used in the art, and the method of determining the process conditions thereof is well known to persons skilled in the art.

The instant solid beverage, especially for a type of fruit flavour, a type of coffee or a type of chocolate, produced by the above processes of the present invention have a more authentic taste than that of an instant solid beverage in powder or granule produced by a traditional process in the art, particularly in terms of fresh fruits, coffee and cocoa materials. The reason might lie in that the dispersion and immobilization function of the carbohydrate matrix as a carrier on the beverage concentrate, which prevents effectively the beverage concentrate from oxidizing or absorbing moisture.

### Use

The instant solid beverage of the present invention can be used for the preparation of a product foodstuff or a beverage or an intermediate product thereof. The foodstuff or beverage can be selected from a group consisting of ice cream, cake, bread, cheese, biscuits, cookies, coffee, milk, candy, and chocolate.

The instant solid beverage has an increased solubility and flowability and can release a better flavor and taste. Due to the encapsulation the beverage concentrate material in the carbohydrate matrix material, the granular instant solid beverage can deliver a higher quality authentic flavour and taste than the traditional commercial solid beverage. The instant solid beverage exhibits a better stability of physical properties compared with existing powdered beverage mixtures. In particular, the granule has a better flowability due to less influence from static electricity between granules and a better solubility due to a porous structure rendering easy penetration of water. Accordingly, the granular instant solid beverage can be particularly used for the preparation of a beverage in a beverage dispenser, the instant solid beverage being stored, dosed and mixed with a diluent in the beverage dispenser.

Further, features described for different embodiments of the present invention may be combined.

Further advantages and features of the present invention are apparent from the figures and examples.

### EXAMPLES

### Measuring Methods

The following definitions of terms and determination methods apply for the above general description of the invention as well as to the below examples unless otherwise defined.

1. Measurement of an Angle of Repose

The solid beverage is unpacked, placed in an open container, and allowed to stand for 24-48 hrs at room temperature in an environment with a relative humidity of 50-65%. Then, the angle of repose is measured according to the method as described in US PHARMACOPEIA, General Chapters: <1174> POWDER FLOW, by using a BT-1000 Model Powder Integrative Characteristic Tester (manufacturer: Dandong Better Instrument Co., Ltd).

2. Measurement of the Dissolution Rate

To a 200 mL beaker, 100 mL of pure water is added, and then 3 g of a solid beverage is added with stirring by a stirrer at a rotation rate of 50 rpm. The time for uniform dissolution of the solid beverage is measured.

3. Measurement of Porosity of the Solid Beverage

The porosity n of the solid beverage is calculated via the formula below:

$$n = ( 1 - \frac{{ρ}_{g}}{{ρ}_{s}} ) \times 100 \%$$

with ρ_{g}=true density, ρₛ=bulk density.

### Example 1

### Preparation of New Instant Orange Type Granules

According to the formulation of the commercially available instant Nestlé® Orange C, orange type granules were prepared by using a wet granulation-fluidized bed drying process with an orange juice concentrate (having a water content of 32%), sucrose as carbohydrate material and some food additives in the same formulation ratios. Table 1 shows the formulation of the raw materials and the process conditions.

The particle size, water content, angle of repose, porosity, and dissolution rate of the instant orange type granules were determined. The results are shown in Table 2.

TABLE 1

| | Example 1 | | |
|---|---|---|---|
| | Beverage | | |
| Item and | concentrate | Carbohydrate | Additive |
| Ingredient | (Content g) | (Content g) | (Content g) |
| Orange juice | 975.1 | | |
| concentrate | | | |
| Sucrose | | 8430.1 | |
| Citric acid | | | 281.7 |
| CMC-Na | | | 67.2 |
| Acesulfame | | | 19.5 |
| (Sweetener) | | | |
| Trichlorosucrose | | | 2.1 |
| (Sweetener) | | | |
| Vitamin C | | | 29.3 |
| Orange essence | | | 97.5 |
| Beta-carotene | | | 97.5 |

| | |
|---|---|
| Granulation | Wet granulation-fluidized bed drying |
| process | |
| Process conditions | 1. pulverizing the solid materials, and controlling |
| | the particle size to be not higher than 200 μm, |
| | wherein the particle sizes of 75% of all solid |
| | materials fall within the range 150 μm to 190 μm; |
| | 2. mixing the solid materials and the orange juice |
| | concentrate by using a Lodige ® FKM 300D |
| | Mixer, wherein the total water content of the |
| | mixture is 7 wt %; |
| | 3. granulation by using a YK160-2 Model |
| | Granulator manufactured by Taixing |
| | Pharmaceutical Machinery Co., Ltd., to prepare |
| | granules having a particle size of 1.5 mm; and |
| | 4. drying by using a ZLG0.2 × 2 Model Vibration |
| | Fluidized Bed at a temperature of 65-75° C. |
| Granule | Column shape, equivalent circle diameter: 1.5 mm |
| Porosity | 45% |
| Water content | Average 2.0 wt % |
| of granules | |

### Comparative Example

### Comparison of the Solid Beverage of the Present Invention with a Commercially Available Solid Beverage

The angles of repose after 24 and 48 hrs, the porosity, and the dissolution rate of the instant orange type granules of Example 1 and that of commercially available instant Nestle® Orange C were measured. This available instant Nestle® Orange C powder presents the following composition in weight:

| | |
|---|---|
| Sucrose | 95.94 |
| Citric acid | 3.023 |
| CMC | 0.40 |
| Vitamin C | 0.20 |
| Orange flavour | 0.40 |
| Colorant | 0.037 |

The results are shown in Table 2 below.

TABLE 2

| Item | Example 1 | Nestle ® Orange C |
|---|---|---|
| Particle | Column shape, | Powder |
| | particle size: 1.5 mm | |
| Angle of repose | 23° | 38° |
| after 24 hrs | | |
| Angle of repose | 30° | 46° |
| after 48 hrs | | |
| Dissolution rate | 25 s | 45 s |

The results indicate that the dissolution rate and the flowability after exposure to the air of the instant solid beverage granules of the present invention are better than those of the prior art. Even after 48 hrs of exposure to the air, the flowability of the solid beverage granules of the present invention is sufficient to be used in a beverage vending machine.

### Example 2

### Preparation of New Instant Chocolate Granules

Instant granules of a type of chocolate were prepared by using a wet granulation-fluidized bed drying process with a cocoa concentrate (having a water content of 60%), sucrose as a carbohydrate material and some food additives. Table 3 shows the formulation of the raw materials and the process conditions.

TABLE 3

| | Example 2 | | |
|---|---|---|---|
| | Beverage | | |
| Item and | concentrate | Carbohydrate | Additive |
| Ingredient | (Content g) | (Content g) | (Content g) |
| Cocoa | 798.4 | | |
| concentrate | | | |
| Sucrose | | 7443.1 | |
| Non-dairy | | | 1566.7 |
| creamer | | | |
| CMC-Na | | | 30.2 |
| Salt | | | 149.3 |
| Chocolate | | | 12.3 |
| essence | | | |

| | |
|---|---|
| Granulation | Wet granulation-fluidized bed drying |
| process | |
| Process | 1. pulverizing the solid materials, and controlling |
| conditions | the particle size to be not higher than 200 μm, |
| | wherein the particle sizes of 75% of all solid |
| | materials fall within the range 130 μm to 190 μm; |
| | 2. mixing the solid materials and the orange juice |
| | concentrate by using a Lodige ® FKM 300D |
| | Mixer, wherein the total water content of the |
| | mixture is 8 wt %; |
| | 3. granulation by using a YK160-2 Model |
| | Granulator manufactured by Taixing |
| | Pharmaceutical Machinery Co., Ltd., to |
| | prepare granules having a particle size of 1.5 |
| | mm; and |
| | 4. drying by using a ZLG0.2 × 2 Model |
| | Vibration Fluidized Bed at a temperature of |
| | 75-95° C. |
| Granule | Column shape, equivalent circle diameter: |
| | 1.5 mm |
| Porosity | 25% |
| Water content | Average 1.5 wt % |
| of granules | |

### Example 3

### Preparation of New Instant Coffee Granules

Instant granules of a type of coffee were prepared by using a wet granulation-fluidized bed drying process with a coffee concentrate (having a water content of 60%), sucrose as a carbohydrate material and non-dairy creamer as a food additive. Table 4 shows the formulation of the raw materials and the process conditions.

TABLE 4

| | Example 3 | | |
|---|---|---|---|
| | Beverage | | |
| Item and | concentrate | Carbohydrate | Additive |
| Ingredient | (Content g) | (Content g) | (Content g) |
| Coffee | 1000 | | |
| concentrate | | | |
| Sucrose | | 7500 | |
| Non-dairy | | | 1500 |
| creamer | | | |

| | |
|---|---|
| Granulation | Wet granulation-fluidized bed drying |
| process | |
| Process | 1. pulverizing the solid materials sucrose and |
| conditions | non-dairy creamer, and controlling the particle |
| | size to be not higher than 200 μM, wherein the |
| | particle sizes of 75% of all solid materials fall |
| | within the range 140 μM to 190 μm; |
| | 2. mixing the solid materials and the orange juice |
| | concentrate by using a Lodige ® FKM 300D |
| | Mixer, wherein the total water content of the |
| | mixture is 6 wt %; |
| | 3. granulation by using a YK160-2 Model |
| | Granulator manufactured by Taixing |
| | Pharmaceutical Machinery Co., Ltd., to prepare |
| | granules having a particle size of 2.0 mm; and |
| | 4. drying by using a ZLG0.2 × 2 Model Vibration |
| | Fluidized Bed at a temperature of 85-95° C. |
| Granule | Column shape, equivalent circle diameter: 2.0 mm |
| Porosity | 35% |
| Water | Average 1.2 wt % |
| content | |
| of granules | |

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention.

Therefore, it is to be understood that, within the scope of the appended claims, the invention may be practiced other than as specifically described herein.

1. An instant solid beverage in the form of granules, each granule comprising:
0.1 to 30% by weight of a beverage concentrate;
60 to 95% by weight of a carbohydrate: and,
particles of the carbohydrate construct a meshwork structure of the granule, and
debris or drops of the beverage concentrate inset dispersedly among the carbohydrate particles meshwork structure and/or debris or drops of the beverage concentrate act as linkage bridges between particles of the carbohydrate meshwork structure, and pores are dispersed within the meshwork structure.

2. The instant solid beverage according to claim 1, wherein when exposed in the air for 24 hours, the instant solid beverage has an angle of repose of α≦40°.

3. The instant solid beverage according to claim 1, wherein the volume of the pores accounts for 5-50 v/v % of that of the granule.

4. The instant solid beverage according to claim 1, comprising 0-10 wt % of an auxiliary food additive.

5. The instant solid beverage according to claim 1, comprising 0.2-5.0 wt % of water.

6. The instant solid beverage according to claim 1, wherein a raw material of the beverage concentrate is selected from the group consisting of tea and tea extract, baking foodstuff extract, foodstuff juice, fruit pulp, fruit juice, vegetable pulp, vegetable juice, milk, condensed/concentrated milk, coffee concentrate, cocoa concentrate or chicories concentrate, fragrant plant extract, herbal extract, meat broth, synthetic flavor, and the combination thereof.

7. The instant solid beverage according to claim 1, wherein the carbohydrate is selected from the group consisting of starch, modified starch, baking foodstuff powder, gelatin, methylcellulose, hydroxypropyl methylcellulose, sodium carboxyl methyl cellulose, ethylcellulose, chitosan, dextrin, sorbitol, xylitol, lactose, galactose, maltose, isomaltitol, sucrose, glucose, arabinose, melibiose, mannoside, raffinose, and cellobiose.

8. The instant solid beverage according to claim 1, wherein the auxiliary food additive is selected from the group consisting of flavouring agent, edible flavour, edible pigment, edible anti-static agent, edible anti-adhesion agent, edible moisture resistant agent, sweetener, nutrient supplement, disintegrant, expanding agent, lipid, surfactant, preservative, anti-oxidant, sodium chloride, and sodium bicarbonate.

9. The instant solid beverage according to claim 1, wherein it is an instant solid beverage of a type of fruit flavour.

10. The instant solid beverage according to claim 1, wherein it is an instant solid beverage of a type of coffee.

11. The instant solid beverage according to claim 1, wherein it is an instant solid beverage of a type of chocolate.

12. A method for preparing the instant solid beverage comprising:
mixing materials of a beverage concentrate and carbohydrate particles with water, and adding auxiliary food additives if necessary, so as to form a mixture, the mixture having a water content ensuring that the viscosity of the mixture is suitable for forming soft granules in a granulator;
subjecting the mixture to a wet granulation, so as to obtain soft granules; and
fluidized-bed drying the soft granules and cooling to room temperature, so as to obtain a granular product containing 0.2-5.0 wt % of water,

13. A method for preparing the instant solid beverage comprising:
pulverizing a material of the carbohydrate particles, or mixing and pulverizing the carbohydrate particles and if necessary auxiliary food additive(s), so as to form a powder having a particle size of not more than 200 μm; and
granulating in a fluidized-bed granulator by taking the powder as a suspension material and taking an aqueous liquid comprising the beverage concentrate or an aqueous liquid comprising the beverage concentrate and if necessary auxiliary food additive(s) as an agglutinant, and then cooling, so as to form granular products containing 0.2 to 5% by weight of water, wherein the agglutinant has a water content ensuring the viscosity of the agglutinant suitable for forming granules in the granulator.

14. A method for the preparation of a product foodstuff or a beverage or an intermediate product thereof comprising using an instant solid beverage comprising 0.1 to 30% by weight of a beverage concentrate;
60 to 95% by weight of a carbohydrate; and
particles of the carbohydrate construct a meshwork structure of the granule, and
debris or drops of the beverage concentrate inset dispersedly among the carbohydrate particles meshwork structure and/or debris or drops of the beverage concentrate act as linkage bridges between particles of the carbohydrate meshwork structure, and pores are dispersed within the meshwork structure.

15. Method according to claim 14 wherein the preparation is made in a beverage dispenser, the instant solid beverage being stored, dosed and mixed with a diluent in the beverage dispenser.

16. Method according to claim 14, wherein the foodstuff or beverage is selected from the group consisting of ice cream, cake, bread, cheese, biscuits, cookies, coffee, milk, candy, and chocolate.

17. A product foodstuff or a beverage or an intermediate product thereof prepared with the instant solid beverage in the form of granules, each granule comprising:
0.1 to 30% by weight of a beverage concentrate;
60 to 95% by weight of a carbohydrate; and
particles of the carbohydrate construct a meshwork structure of the granule, and
debris or drops of the beverage concentrate inset dispersedly among the carbohydrate particles meshwork structure and/or debris or drops of the beverage concentrate act as linkage bridges between particles of the carbohydrate meshwork structure, and pores are dispersed within the meshwork structure.
